(19) United States
(12) Patent Application Publication
(10) Pub. No.: US 2016/0245097 A1
(43) Pub. Date: Aug. 25, 2016

(54) AIRFOIL AND METHOD FOR MANUFACTURING AN AIRFOIL

(71) Applicant: General Electric Company, Schenectady, NY (US)

(72) Inventors: Mark Andrew Jones, Ponte Vedra Beach, FL (US); Aaron Ezekiel Smith, Montgomery, OH (US)

(21) Appl. No.: 15/142,640

(22) Filed: Apr. 29, 2016

Related U.S. Application Data
(63) Continuation of application No. 13/600,717, filed on Aug. 31, 2012.

(51) Int. Cl. F01D 5/18; F01D 25/12; F01D 9/04

(52) U.S. Cl. CPC F01D 5/187; F01D 9/041; F01D 25/12; F05D 2220/32; F05D 2260/202

(57) ABSTRACT

An airfoil includes a pressure side, a suction side opposed to the pressure side, a cavity inside the airfoil between the pressure and suction sides, and a trailing edge downstream from the cavity between the pressure and suction sides. A first set of cooling passages through the trailing edge provide fluid communication from the cavity through the trailing edge. A first divider across each cooling passage in the first set of cooling passages extends from the pressure side to the suction side at the trailing edge.

### CROSS REFERENCE TO RELATED APPLICATIONS

The present application claims filing benefit of U.S. patent application Ser. No. 13/600,717 having a filing date of Aug. 31, 2012, which is incorporated by reference herein in its entirety.

### FIELD OF THE INVENTION

The present invention generally involves an airfoil and a method for manufacturing an airfoil.

### BACKGROUND OF THE INVENTION

Turbines are widely used in industrial and commercial operations. A typical commercial steam or gas turbine used to generate electrical power includes alternating stages of stationary and rotating airfoils. For example, stationary vanes may be attached to a stationary component such as a casing that surrounds the turbine, and rotating blades may be attached to a rotor located along an axial centerline of the turbine. A compressed working fluid, such as but not limited to steam, combustion gases, or air, flows through the turbine, and the stationary vanes accelerate and direct the compressed working fluid onto the subsequent stage of rotating blades to impart motion to the rotating blades, thus turning the rotor and performing work or generating thrust.

The efficiency of the turbine generally increases with increased temperatures of the compressed working fluid. However, excessive temperatures within the turbine may reduce the longevity of the airfoils in the turbine and thus increase repairs, maintenance, and outages associated with the turbine. As a result, various designs and methods have been developed to provide cooling to the airfoils. For example, a cooling media may be supplied to a cavity inside the airfoil to convectively and/or conductively remove heat from the airfoil. In particular embodiments, the cooling media may flow out of the cavity through cooling passages in the airfoil to provide film cooling over the outer surface of the airfoil.

The cavity and cooling passages in the airfoil may be manufactured using an investment casting process commonly referred to as a lost wax process. The lost wax process uses a ceramic core to define the cavity inside the airfoil. A wax is applied over the ceramic core, and the wax surface is shaped into the desired curvature for the airfoil. The wax-covered ceramic core is then repeatedly dipped into a liquid ceramic solution to create a ceramic shell over the wax surface. The wax may then be heated to remove the wax from between the ceramic core and the ceramic shell, creating a void between the ceramic core and the ceramic shell that serves as a mold for the airfoil. Molten metal may then be poured into the mold to form the airfoil. After the metal cools and solidifies, the ceramic shell may be broken and removed, exposing the metal that has taken the shape of the void created by the removal of the wax. The ceramic core may then be dissolved to produce the airfoil with the cavity and cooling passages.

Various efforts have been attempted to reduce the amount of cooling media flowing through the airfoil. For example, reducing the size and/or width of the cooling passages may enhance heat transfer to the cooling media while also reducing the amount of cooling media flowing through the airfoil. However, the smaller cooling passages require correspondingly smaller projections from the ceramic core that are sensitive to damage during the casting process. In particular, the projections from the ceramic core near either end of the ceramic core are susceptible to breaking off during casting. In an effort to strengthen the ceramic core while still providing smaller cooling passages, the projections from the ceramic core may be larger at either end and narrower in the middle. However, the larger projections may result in uneven cooling media flow through the correspondingly larger cooling passages, depriving the smaller cooling passages in the middle of the airfoil of sufficient cooling media flow. Accordingly, an airfoil and method for manufacturing an airfoil that produces a desired cooling media flow profile through cooling passages in the airfoil would be useful.

### BRIEF DESCRIPTION OF THE INVENTION

Aspects and advantages of the invention are set forth below in the following description, or may be obvious from the description, or may be learned through practice of the invention.

One embodiment of the present invention is an airfoil that includes a pressure side, a suction side opposed to the pressure side, a cavity inside the airfoil between the pressure and suction sides, and a trailing edge downstream from the cavity between the pressure and suction sides. A first set of cooling passages through the trailing edge provide fluid communication from the cavity through the trailing edge. A first divider across each cooling passage in the first set of cooling passages extends from the pressure side to the suction side at the trailing edge.

Another embodiment of the present invention is an airfoil that includes a pressure side, a suction side opposed to the pressure side, a cavity inside the airfoil between the pressure and suction sides, and a trailing edge downstream from the cavity between the pressure and suction sides. A first set of cooling passages through the trailing edge provide fluid communication from the cavity through the trailing edge. A first set of pins extend across each cooling passage in the first set of cooling passages upstream from the trailing edge.

The present invention may also include an airfoil having a pressure side, a suction side opposed to the pressure side, a cavity inside the airfoil between the pressure and suction sides, and a trailing edge downstream from the cavity between the pressure and suction sides. A first set of cooling passages through the trailing edge provide fluid communication from the cavity through the trailing edge. A second set of cooling passages through the trailing edge provide fluid communication from the cavity through the trailing edge, and the first set of cooling passages are wider than the second set of cooling passages. The airfoil further includes first means for reducing flow through the first set of cooling passages.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of an airfoil according to a first embodiment of the present invention;

FIG. 2 is a plan view of a core for manufacturing the airfoil shown in FIG. 1;

FIG. 3 is a perspective view of an airfoil according to a second embodiment of the present invention;

FIG. 4 is a plan view of a core for manufacturing the airfoil shown in FIG. 3;

FIG. 5 is a perspective view of an airfoil according to a third embodiment of the present invention;

FIG. 6 is a plan view of a core for manufacturing the airfoil shown in FIG. 5;

FIG. 7 is a perspective view of an airfoil according to a fourth embodiment of the present invention;

FIG. 8 is a plan view of a core for manufacturing the airfoil shown in FIG. 7; and

FIG. 9 is an exemplary graph of stresses in the core shown in FIG. 8.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include an airfoil and a method for manufacturing an airfoil. The airfoil generally includes a pressure side having a concave curvature, a suction side having a convex curvature and opposed to the pressure side, a cavity inside the airfoil between the pressure and suction sides, and a trailing edge downstream from the cavity between the pressure and suction sides. The airfoil further includes one or more sets of cooling passages through the trailing edge that provide fluid communication from the cavity through the trailing edge. One or more of the sets of cooling passages may include various means for reducing flow through the cooling passages. In particular embodiments, for example, the means may include one or more dividers across some of the cooling passages at the trailing edge. In other particular embodiments, the means may include a set of pins that extend across some of the cooling passages. Although exemplary embodiments of the present invention will be described generally in the context of an airfoil incorporated into a turbine, one of ordinary skill in the art will readily appreciate from the teachings herein that embodiments of the present invention are not limited to a turbine unless specifically recited in the claims.

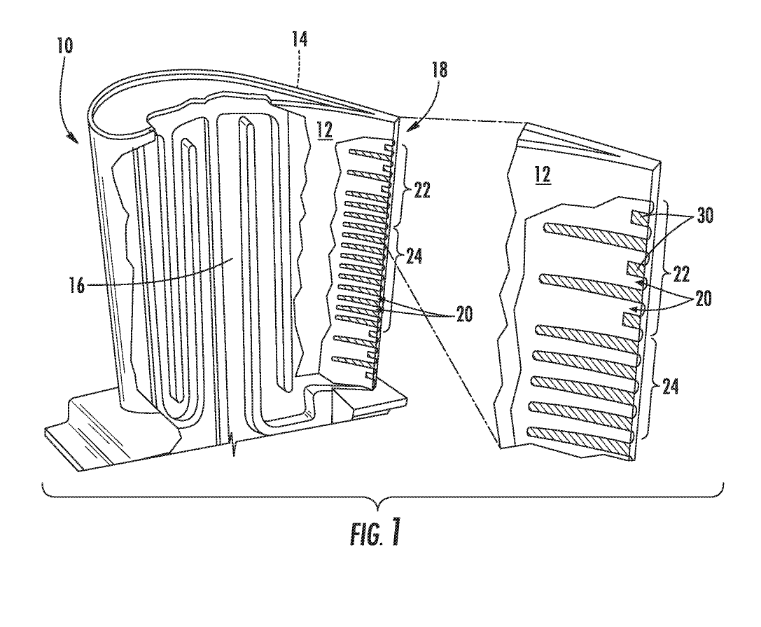

Referring now to the drawings, wherein identical numerals indicate the same elements throughout the figures, FIG. 1 provides a perspective view of an airfoil 10 according to a first embodiment of the present invention. As shown in FIG. 1, the airfoil 10 generally includes a pressure side 12 having a concave curvature and a suction side 14 having a convex curvature and opposed to the pressure side 12. The pressure and suction sides 12, 14 are separated from one another to define a cavity 16 inside the airfoil 10 between the pressure and suction sides 12, 14. The cavity 16 may provide a serpentine or tortuous path for a cooling media to flow inside the airfoil 10 to remove heat from the airfoil 10. The airfoil 10 further includes a trailing edge 18 downstream from the cavity 16 between the pressure and suction sides 12, 14, and a plurality of cooling passages 20 through the trailing edge 18 provide fluid communication from the cavity 16 through the trailing edge 18. As used herein, the term “trailing edge” is not limited to the most downstream portion of the airfoil 10 and may instead also include portions of the airfoil 10 on the pressure and/or suction sides 12, 14 that are downstream from the cavity 16.

The cooling passages 20 may be arranged in multiple sets, with each set of cooling passages 20 having a different size, shape, and/or width. For example, a first set of cooling passages 22 located at the top and bottom of the trailing edge 18 may have a larger size and/or width than a second set of cooling passages 24 located in the middle of the trailing edge 18. In the particular embodiment shown in FIG. 1, for example, the first set of cooling passages 22 may include three cooling passages 20 at the top and three cooling passages 20 at the bottom of the trailing edge 18. As shown in FIG. 1, each cooling passage 20 may be tapered axially, and each cooling passage 20 in the first set of cooling passages 22 may have a size and/or width that is approximately three times as large as each cooling passage 20 in the second set of cooling passages 24. One of ordinary skill in the art will readily appreciate from the teachings herein that the number of cooling passages 20 in the first set of cooling passages 22 may vary between 1 and 10 or more, and the present invention is not limited to any particular number of cooling passages 20 in any set of cooling passages 22, 24 unless specifically recited in the claims. Similarly, the difference in size, and/or width between the sets of cooling passages 20 may vary between approximately 1.1 times and 10 times or more, depending on the size of the airfoil 10 and number of different sets of cooling passages 22, 24 in the airfoil 10, and the present invention is not limited to any particular difference in size and/or width of cooling passages 20 unless specifically recited in the claims.

The difference in size, shape, and/or width between the first and second sets of cooling passages 22, 24 would ordinarily create an undesirable disparity in cooling media flow along the length of the trailing edge 18. Specifically, the larger size and/or width of the first set of cooling passages 22 would result in more cooling media flowing through the first set of cooling passages 22, possibly resulting in insufficient cooling media flow through the second set of cooling passages 24. To reduce this disparity, the first set of cooling passages 22 may further include means for reducing flow through the first set of cooling passages 22. In the particular embodiment shown in FIG. 1, for example, the structure associated with the means may include a first divider 30 across each cooling passage 20 in the first set of cooling passages 22. Each first divider 30 is essentially a post, tab, stub, pin, or similar structure that may extend from the pressure side 12 to the suction side 14 at the trailing edge 18. As a result, each first divider 30 may partially obstruct cooling media flow through each cooling passage 20 in the first set of cooling passages 22 to reduce any disparity in cooling media flow along the length of the trailing edge 18. Additionally, the first set of cooling passages 22 may be tapered more than the other cooling passages 20 to reduce this disparity even further.

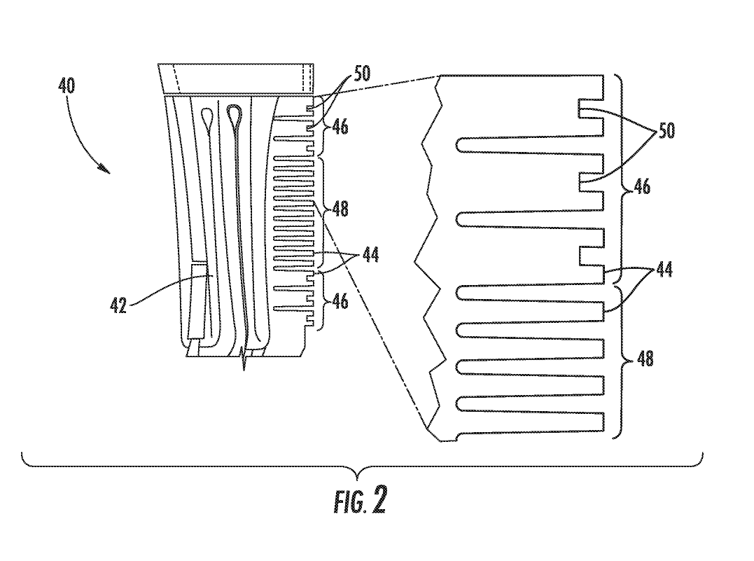

FIG. 2 provides a plan view of a core 40 that may be used to manufacture the airfoil 10 shown in FIG. 1. As shown in FIG. 2, the core 40 may include a serpentine portion 42 with a number of long, thin branches or projections 44 that extend from the serpentine portion 42. The serpentine portion 42 generally corresponds to the size and location for the cavity 16 in the airfoil 10, and the projections 44 generally correspond to the size and location of the cooling passages 20 through the trailing edge 18. For example, as shown in FIG. 2, the projections 44 may be grouped into a first set of projections 46 at the top and bottom of the core 40 that are approximately three times the size and/or width of the remaining projections 44 in a second set of projections 48 in the middle of the core 40. In addition, the first set of projections 46 include tabs or notches 50 that generally correspond to the location of the first dividers 30 in the first set of cooling passages 22 described with respect to FIG. 1. The increased size and/or width of the first set of projections 46 enhances the durability and resistance to damage of the projections 44 during the subsequent casting operations.

The core 40 may be manufactured from any material having sufficient strength to withstand the high temperatures associated with the casting material (e.g., a high alloy metal) while maintaining tight positioning required for the core 40 during casting. For example, the core 40 may be cast from ceramic material, ceramic composite material, or other suitable materials. Once cast or otherwise manufactured, a laser, electron discharge machine, drill, water jet, or other suitable device may be used to refine or form the serpentine portion 42, projections 44, and/or notches 50 shown in FIG. 2. The core 40 may then be utilized in a lost wax process as is known in the art. For example, the core 40 may be coated with a wax or other suitable material readily shaped to the desired thickness and curvature for the airfoil 10. The wax covered core 40 may then be repeatedly dipped into a liquid ceramic solution to create a ceramic shell over the wax surface. The wax may then be heated to remove the wax from between the core 40 and the ceramic shell, creating a void between the core 40 and the ceramic shell that serves as a mold for the airfoil 10. Molten metal may then be poured into the mold to form the airfoil 10. After the metal cools and solidifies, the ceramic shell may be broken and removed, exposing the metal that has taken the shape of the void created by the removal of the wax. The core 40 may then be dissolved to produce the airfoil 10 with the cavity 16, cooling passages 20, and first dividers 30 shown in FIG. 1.

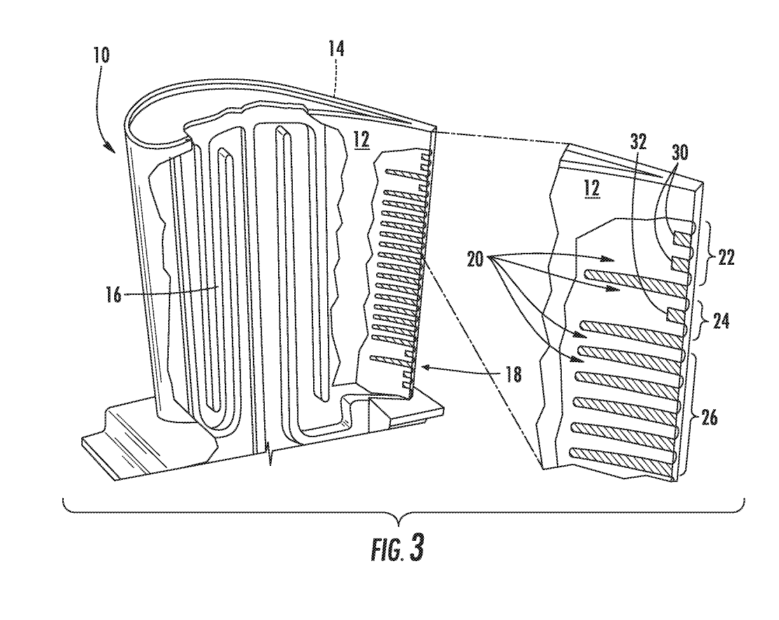

FIG. 3 provides a perspective view of the airfoil 10 according to a second embodiment of the present invention. As shown in FIG. 3, the airfoil 10 generally includes the pressure side 12, suction side 14, cavity 16, trailing edge 18, and cooling passages 20 as previously discussed with respect to FIG. 1. In this particular embodiment, the cooling passages 20 are arranged in first, second, and third sets of cooling passages 22, 24, 26, with each set of cooling passages 20 having a different size and/or width. As shown in FIG. 3, for example, the first set of cooling passages 22 includes a single cooling passage 20 located at the top and bottom of the trailing edge 18, the second set of cooling passages 24 includes a single cooling passage 20 located next to each cooling passage 20 in the first set of cooling passages 22, and the third set of cooling passages 26 includes the remaining cooling passages 20 located in the middle of the trailing edge 18. In the particular embodiment shown in FIG. 3, each cooling passage 20 may be tapered axially. Each cooling passage 20 in the first set of cooling passages 22 may have a size and/or width that is approximately five times as large as each cooling passage 20 in the third set of cooling passages 26, and each cooling passage 20 in the second set of cooling passages 24 may have a size and/or width that is approximately three times as large as each cooling passage 20 in the third set of cooling passages 26. One of ordinary skill in the art will readily appreciate from the teachings herein that the number of cooling passages 20 in the first and second sets of cooling passages 22, 24 may vary between 1 and 10 or more, and the present invention is not limited to any particular number of cooling passages 20 in any set of cooling passages 22, 24, 26 unless specifically recited in the claims. Similarly, the difference in size and/or width between the sets of cooling passages 22, 24, 26 may vary between approximately 1.1 times and 10 times or more, depending on the size of the airfoil 10 and number of different sets of cooling passages 22, 24, 26 in the airfoil 10, and the present invention is not limited to any particular difference in size, shape, and/or width of cooling passages 20 unless specifically recited in the claims.

The difference in size, shape, and/or width between the first, second, and third sets of cooling passages 22, 24, 26 would ordinarily create an undesirable disparity in cooling media flow along the length of the trailing edge 18. Specifically, the larger size and/or width of the first and second sets of cooling passages 22, 24 would result in more cooling media flowing through the first and second sets of cooling passages 22, 24, possibly resulting in insufficient cooling media flow through the third set of cooling passages 26. To reduce this disparity, the first and/or second sets of cooling passages 22, 24 may further include means for reducing flow through the respective cooling passages 20. In the particular embodiment shown in FIG. 3, for example, the structure associated with the means in the first set of cooling passages 22 may include multiple first dividers 30 across each cooling passage 20 in the first set of cooling passages 22. Each first divider 30 is essentially a post, tab, stub, pin, or similar structure that may extend from the pressure side 12 to the suction side 14 at the trailing edge 18. As a result, the multiple first dividers 30 may partially obstruct cooling media flow through each cooling passage 20 in the first set of cooling passages 22. The structure associated with the means in the second set of cooling passages 24 may similarly include one or more second dividers 32 across each cooling passage 20 in the second set of cooling passages 24. The combination of the means for reducing flow through the first and second sets of cooling passages 22, 24 reduces any disparity in cooling media flow along the length of the trailing edge 18. Additionally, the first and/or second set of cooling passages 22, 24 may be tapered more than the third set of cooling passages 26 to reduce this disparity even further.

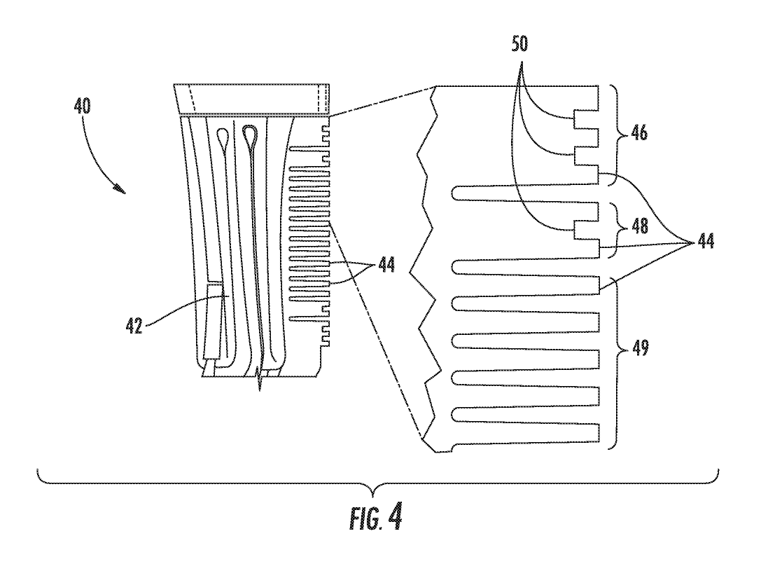

FIG. 4 provides a plan view of the core 40 that may be used to manufacture the airfoil 10 shown in FIG. 3. As shown in FIG. 4, the core 40 may again include the serpentine portion 42, projections 44, and notches 50 as previously described with respect to FIG. 2. In the particular embodiment shown in FIG. 4, the projections 44 are arranged in first, second, and third sets of projections 46, 48, 49 that correspond to the location and sizes of the cooling passages 20 in the first, second, and third sets of cooling passages 22, 24, 26, respectively. Specifically, the first set of projections 46 include the projections 44 at the top and bottom of the core 40 that are approximately five times the size and/or width of the projections 44 in the third set of projections 49. Similarly, the second set of projections 48 include the projections 44 adjacent to the first set of projections 46 that are approximately three times the size and/or width of the projections 44 in the third set of projections 49. Lastly, the third set of projections 49 are located in the middle of the core 40. In addition, the first and second sets of projections 46, 48 include the tabs or notches 50 that generally correspond to the location of the first and second dividers 30, 32 in the first and second sets of cooling passages 22, 24 described with respect to FIG. 3. The increased size and/or width of the first and second sets of projections 46, 48 enhances the durability and resistance to damage of the projections 44 during the subsequent casting operations.

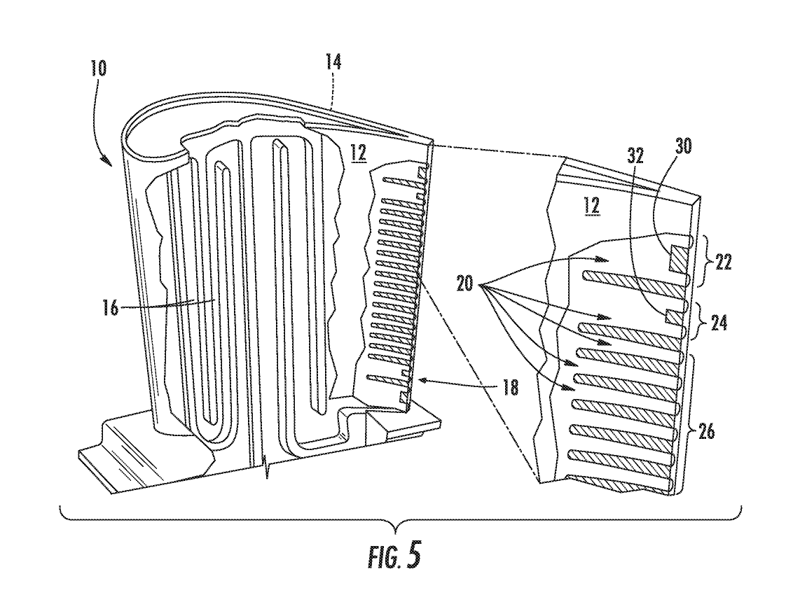

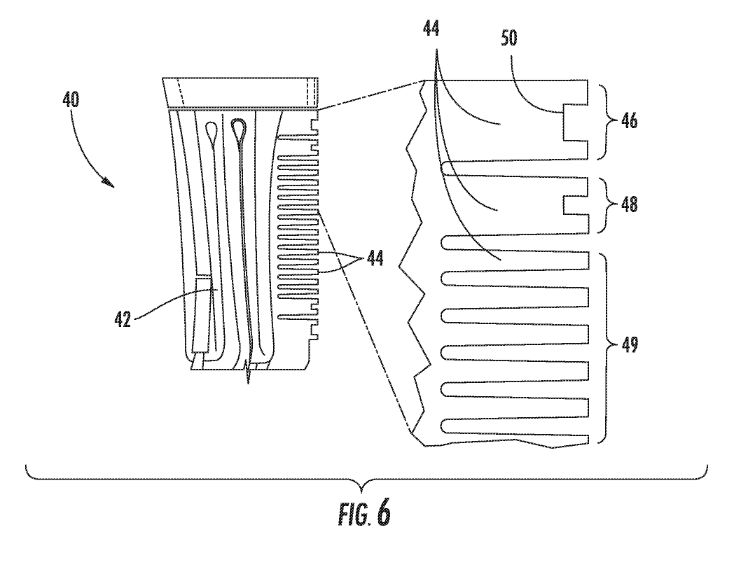

FIG. 5 provides a perspective view of the airfoil 10 according to a third embodiment of the present invention, and FIG. 6 provides a plan view of the core 40 for manufacturing the airfoil 10 shown in FIG. 5. As shown in FIGS. 5 and 6, the airfoil 10 and core 40 generally include the same components as previously described with respect to the embodiments shown in FIGS. 1-4. In this particular embodiment, each cooling passage 20 may be tapered axially. Each cooling passage 20 in the first set of cooling passages 22 may have a size and/or width that is approximately four times as large as each cooling passage 20 in the third set of cooling passages 26, and each cooling passage 20 in the second set of cooling passages 24 may have a size and/or width that is approximately three times as large as each cooling passage 20 in the third set of cooling passages 26. The structure associated with the means for reducing flow through the cooling passages 20 in the first and second sets of cooling passages 22, 24 again includes first and second dividers 30, 32, as previously described with respect to FIG. 3. However, in the particular embodiment shown in FIG. 5, each first divider 30 is wider than each second divider 32. Specifically, each first divider 30 may be wider than each second divider 32 by approximately 1.1 to 5 times or more, depending on the particular embodiment. As a result, the wider first dividers 30 may combine with the wider cooling passages 20 in the first set of cooling passages 22 to reduce any disparity in cooling media flow along the length of the trailing edge 18. Additionally, the first and/or second set of cooling passages 22, 24 may be tapered more than the third set of cooling passages 26 to reduce this disparity even further.

As shown most clearly in FIG. 6, the first set of projections 46 include the projections 44 at the top and bottom of the core 40 that are approximately four times the size and/or width of the projections 44 in the third set of projections 49, and the second set of projections 48 include the projections 44 adjacent to the first set of projections 46 that are approximately three times the size and/or width of the projections 44 in the third set of projections 49. The increased size and/or width of the first and second sets of projections 46, 48 enhances the durability and resistance to damage of the projections 44 during the subsequent casting operations.

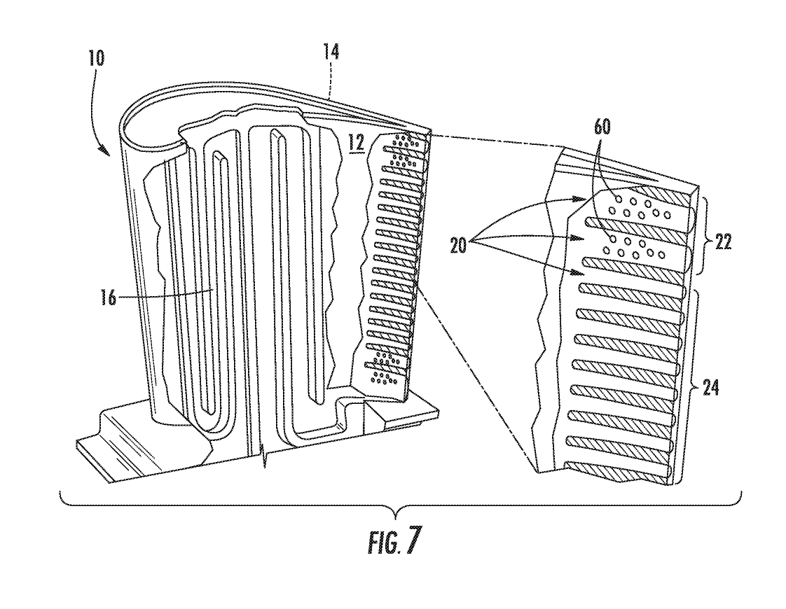

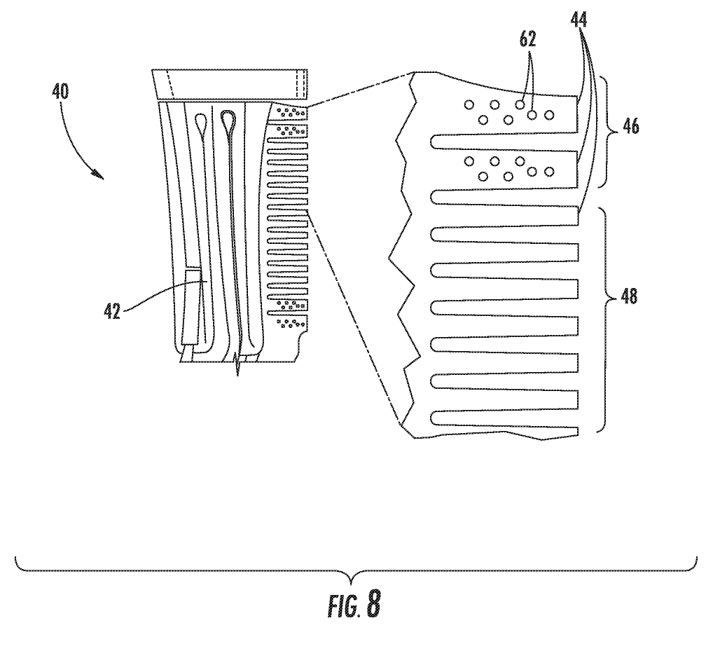

FIG. 7 provides a perspective view of the airfoil 10 according to a fourth embodiment of the present invention, and FIG. 8 provides a plan view of the core 40 for manufacturing the airfoil 10 shown in FIG. 7. Specifically, the airfoil 10 generally includes the pressure side 12, suction side 14, cavity 16, trailing edge 18, and cooling passages 20 as previously discussed with respect to FIG. 1. In this particular embodiment, the first set of cooling passages 22 includes two cooling passages 20 at the top and bottom of the trailing edge 18, and the second set of cooling passages 24 includes the cooling passages 20 located in the middle of the trailing edge 18. Each cooling passage 20 may be tapered axially, and each cooling passage 20 in the first set of cooling passages 22 may have a size and/or width that is approximately three times as large as each cooling passage 20 in the second set of cooling passages 24. The structure associated with the means for reducing flow through the cooling passages 20 in the first set of cooling passages 22 may include a first set of pins 60 that extend across each cooling passage 20 in the first set of cooling passages 22 upstream from the trailing edge 18. The pins 60 may disrupt the cooling media flow through the cooling passages 20 to reduce the amount of cooling media flowing through the first set of cooling passages 22 while also enhancing heat exchange between the airfoil 10 and the cooling media. As shown in the particular embodiment shown in FIG. 7, one or more of the pins 60 may be axially staggered inside the cooling passages 20 to further enhance heat exchange and control cooling media flow through the cooling passages 20. As a result, the first set of pins 60 may combine with the wider cooling passages 20 in the first set of cooling passages 22 to reduce any disparity in cooling media flow along the length of the trailing edge 18. Additionally, the first set of cooling passages 22 may be tapered more than the second set of cooling passages 24 to reduce this disparity even further. One of ordinary skill in the art will readily appreciate from the teachings herein that in still further embodiments, the means for reducing flow through the second set of cooling passages 24 shown in FIGS. 3 and 5 may include a second set of pins in each cooling passage 20 in the second set of cooling passages 24 upstream from the trailing edge 18, and further illustration of this alternate structure is not necessary.

As shown most clearly in FIG. 8, the core 40 may again include the serpentine portion 42 and projections 44 as previously described with respect to FIG. 2. In the particular embodiment shown in FIG. 8, the projections 44 are arranged in first and second sets of projections 46, 48 that correspond to the location and sizes of the cooling passages 20 in the first and second sets of cooling passages 22, 24, respectively. Specifically, the first set of projections 46 include the two projections 44 at the top and bottom of the core 40 that are approximately three times the size and/or width of the projections 44 in the second set of projections 48. In addition, the first set of projections 46 include multiple holes 62 that generally correspond to the location of the first set of pins 60 in the first set of cooling passages 22 described with respect to FIG. 7. The increased size and/or width of the first set of projections 46 enhances the durability and resistance to damage of the projections 44 during the subsequent casting operations.

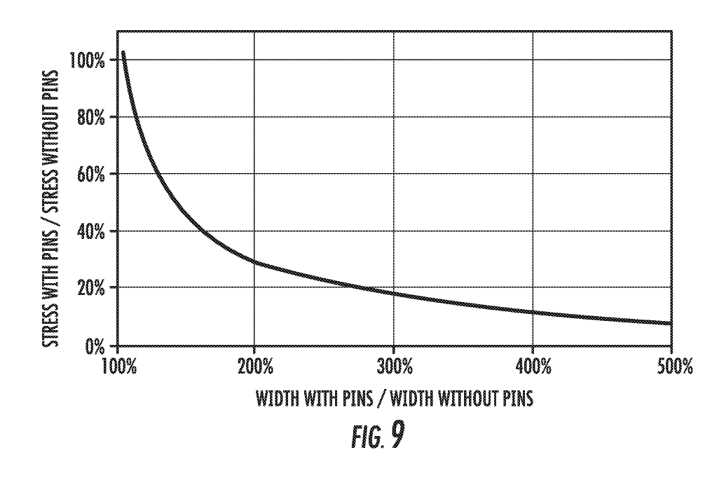

FIG. 9 provides an exemplary graph of stresses in the core 40 shown in FIG. 8. Specifically, the horizontal axis represents the ratio of the width of the projections 44 with and without the pins 60, and the vertical axis represents the ratio of the stress on the projections with and without pins 60. As shown in FIG. 9, doubling the width of the projections 44 and adding pins 60 to the projections reduces the stress across by projections 44 by more than 50%. For the particular embodiment shown in FIG. 8 in which the projections 44 in the first set of projections 46 are approximately three times larger and/or wider than the projections 44 in the second set of projections 48, the stress across the projections 44 in the first set of projections 46 are calculated to be less than 20% of the stress across the projections 44 in the second set of projections 48.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An airfoil, comprising:
a pressure side, a suction side opposed to the pressure side, a leading edge and a trailing edge; and
a plurality of cooling passages defined along the trailing edge of the airfoil between a root portion of the airfoil and a tip portion of the airfoil;
wherein the plurality of cooling passages comprises a first set of cooling passages subdivided into a top set of cooling passages defined proximate to the tip portion, a bottom set of cooling passages defined proximate to the root portion;
wherein the airfoil further comprises a second set of cooling passages defined between the top set of cooling passages and the bottom set of cooling passages;
wherein a first radial distance defined between a first pair of radially spaced walls defining a top cooling passage of the top set of cooling passages is greater than a second radial distance defined between a second pair of radially spaced walls defining a middle cooling passage of the second set of cooling passages;
wherein a third radial distance defined between a third pair of radially spaced walls defining a bottom cooling passage of the bottom set of cooling passages is greater than the second radial distance defined between the pair of radially spaced walls defining the middle cooling passage of the second set of cooling passages; and
wherein at least one of the top cooling passage and the bottom cooling passage includes a plurality of pins that extends from the pressure side to the suction side.

2. The airfoil as in claim 1, wherein both the top cooling passage and the bottom cooling passage comprise a plurality of pins that extends from the pressure side to the suction side.

3. The airfoil as in claim 1, further comprising a cavity defined within the airfoil between the pressure side and the suction side, wherein the plurality of cooling passages is in fluid communication with the cavity.

4. The airfoil as in claim 1, wherein the first pair of radially spaced walls terminates at the trailing edge of the airfoil.

5. The airfoil as in claim 1, wherein the second pair of radially spaced walls terminates at the trailing edge of the airfoil.

6. The airfoil as in claim 1, wherein the third pair of radially spaced walls terminates at the trailing edge of the airfoil.

7. The airfoil as in claim 1, wherein the top set of cooling passages comprises a second top cooling passage.

8. The airfoil as in claim 1, wherein the bottom set of cooling passages comprises a second bottom cooling passage.

9. An airfoil, comprising:
a pressure side, a suction side opposed to the pressure side, a leading edge and a trailing edge; and
a plurality of cooling passages defined along the trailing edge of the airfoil between a root portion of the airfoil and a tip portion of the airfoil;
wherein the plurality of cooling passages comprises a first set of cooling passages subdivided into a top set of cooling passages defined proximate to the tip portion, a bottom set of cooling passages defined proximate to the root portion;
wherein the airfoil further comprises a second set of cooling passages defined between the top set of cooling passages and the bottom set of cooling passages;
wherein a first radial distance defined between a first pair of radially spaced walls defining a top cooling passage of the top set of cooling passages is greater than a second radial distance defined between a second pair of radially spaced walls defining a middle cooling passage of the second set of cooling passages; and
wherein the airfoil further comprises a first plurality of pins that extends between the pressure side and the suction side, wherein the first plurality of pins is disposed within the top cooling passage between the first pair of radially spaced walls.

10. The airfoil as in claim 9, further comprising a cavity defined within the airfoil between the pressure side and the suction side, wherein the plurality of cooling passages is in fluid communication with the cavity.

11. The airfoil as in claim 9, wherein the first pair of radially spaced walls terminates at the trailing edge of the airfoil.

12. The airfoil as in claim 9, wherein the second pair of radially spaced walls terminates at the trailing edge of the airfoil.

13. The airfoil as in claim 9, wherein the top set of cooling passages comprises a second top cooling passage.

14. The airfoil as in claim 9, wherein a third radial distance defined between a third pair of radially spaced walls defining a bottom cooling passage of the bottom set of cooling passages is greater than the second radial distance defined between the pair of radially spaced walls defining the middle cooling passage of the second set of cooling passages.

15. The airfoil as in claim 14, wherein the third pair of radially spaced walls terminates at the trailing edge of the airfoil.

16. The airfoil as in claim 14, further comprising means for reducing flow through the bottom cooling passage.

17. The airfoil as in claim 16, wherein the means for reducing flow through the bottom cooling passage comprises a second plurality of pins that extends between the pressure side and the suction side of the airfoil, wherein the second plurality of pins is disposed within the bottom cooling passage and positioned axially and radially between the third pair of radially spaced walls.
